(19) United States
(12) Patent Application Publication
(10) Pub. No.: US 2024/0042413 A1
(43) Pub. Date: Feb. 8, 2024

(54) A PARTICULATE MAGNESIUM ION-COMPRISING MATERIAL FOR NOX UPTAKE

(71) Applicant: Omya International AG, Oftringen (CH)

(72) Inventors: Kai Max HETTMANN, Grenzach-Wyhlen (DE); Joachim SCHOELKOPF, Oberkulm (DE)

(73) Assignee: Omya International AG, Oftringen (CH)

(21) Appl. No.: 18/257,625

(22) PCT Filed: Dec. 22, 2021
(86) PCT No.: PCT/EP2021/087227

§ 371 Date: Jun. 15, 2023

(30) Foreign Application Priority Data
Jan. 11, 2021 (EP) 21150993.0

(51) Int. Cl. B01J 20/04; B01J 20/28; B01J 20/30

(52) U.S. Cl. CPC B01J 20/041; B01J 20/28059; B01J 20/28061; B01J 20/28004; B01J 20/3071; B01J 20/043; B01J 2220/42

(57) ABSTRACT

The present invention relates to a process for taking up one or more nitrogen oxide(s) from a medium using at least one particulate magnesium ion-comprising material, a particulate magnesium ion-comprising material obtained by the process as well as an adsorbing material comprising said at least one particulate magnesium ion-comprising material and the use of at least one particulate magnesium ion-comprising material having a BET specific surface area as measured by the BET nitrogen method in the range from 4 to 400 m²/g for taking up one or more nitrogen oxide(s) from a gaseous and/or aero

The present invention relates to a process for taking up one or more nitrogen oxide(s) from a medium using at least one particulate magnesium ion-comprising material, a particulate magnesium ion-comprising material obtained by the process as well as an adsorbing material comprising said at least one particulate magnesium ion-comprising material and the use of at least one particulate magnesium ion-comprising material having a BET specific surface area as measured by the BET nitrogen method in the range from 4 to 400 m²/g for taking up one or more nitrogen oxide(s) from a gaseous and/or aerosol medium.

In the last three decades, the pollution of gaseous and aerosol media such as air has become a major environmental concern, especially in urban areas. Pollutants such as nitrogen oxides (NOₓ) contribute to urban air quality problems, e.g. photochemical smog, and are said to adversely affect the health of human beings as well as of animals and plants. These pollutants are typically emitted in the environment from combustion processes such as power and heating plants, and motor vehicles and/or production processes such as industrial plants.

Furthermore, said pollutants are also known as ozone precursors as the major formation of tropospheric ozone results from a reaction of nitrogen oxides (NOₓ) and volatile organic compounds in the atmosphere in the presence of sunlight and carbon monoxide. Moreover, such reaction may cause photochemical smog, especially in summer time, comprising peroxyacetyl nitrate (PAN) and acid rain. Children, people with lung diseases such as asthma, and people who work or exercise outside are susceptible to adverse effects of photochemical smog such as damage to lung tissue and reduction in lung function.

In the art, several attempts have been made to reduce the concentration of pollutants such as nitrogen oxides (NOₓ) in the environment.

For example, a building material with photocatalytic activity towards air pollutants such as NOₓ is described in WO2006000565, wherein the photocatalytic activity arises from the presence of TiO₂ nanoparticles physically mixed with cement. A photocatalytic reactor for oxidation of organic contaminants from gases or water is described in U.S. Pat. No. 6,136,186, wherein the photocatalyst is a porous layer or surface of TiO₂ or a binary TiO₂, eventually doped with another metal catalyst, formed on a porous surface. EP1559753 relates to a photocatalytic potassium silicate paint that contains TiO₂ in the anatase form. The paint is designed for use in residential and public buildings to give anti-pollutant, self-cleaning properties.

The use of calcium carbonate compounds is known in the art for e.g. industrial waste water treatment. For example, JPAH07223813 refers to a porous calcium carbonate compound having a number of pores on the surface which is useful as filter aids.

WO2017153329 A1 refers to a process for taking up one or more nitrogen oxide(s) from a gaseous or aerosol or liquid medium. The process comprising, more preferably consisting of the following steps: a) providing a gaseous and/or aerosol or liquid medium comprising nitrogen oxides, b) providing at least one particulate earth alkali carbonate-comprising material and/or at least one particulate earth alkali phosphate-comprising material having a BET specific surface area as measured by the BET nitrogen method in the range from 4 to 200 m²/g, and c) contacting the gaseous and/or aerosol or liquid medium of step a) with the at least one particulate earth alkali carbonate-comprising material and/or at least one particulate earth alkali phosphate-comprising material of step b) in any order, for taking up at least a part of the one or more nitrogen oxide(s) from the gaseous and/or aerosol or liquid medium onto the surface and/or into the pores of the at least one particulate earth alkali carbonate-comprising material and/or at least one particulate earth alkali phosphate-comprising material, and d) optionally providing at least one particulate calcium carbonate-comprising material and contacting the at least one particulate calcium carbonate-comprising material with the at least one particulate earth alkali carbonate-comprising material and/or at least one particulate earth alkali phosphate-comprising material of step b) before and/or during and/or after step c). The at least one particulate earth alkali carbonate-comprising material and/or at least one particulate earth alkali phosphate-comprising material of step b) is described to be surface-modified calcium carbonate, or surface-modified calcium carbonate in admixture with apatite, magnesium carbonate, hydromagnesite and/or dolomite. JP3113903 B2 refers to a removing agent for removing nitrogen oxides from a combustion exhaust gas containing a compound and a larger amount of oxygen than a theoretical reaction amount for a coexisting unburned component, comprising: at least one selected from a hydroxide, carbonates and bicarbonates of an alkali metal element and an alkaline earth metal element; and a nitrogen oxide remover comprising a zeolite carrying at least one of a simple substance of a transition element selected from the group Pt, Rh, Pd, Ag, Ru, Os, Ir, V, Cr, Mn, Fe, Co, Ni and Cu, an oxide thereof, and a halide thereof. JP2013146693 A refers to an NOx storage and removal catalyst (LNT) in an exhaust gas having a catalyst layer containing at least two layers of a noble metal element on an integral structure type support, a zirconia-based composite oxide (A) supporting rhodium on the upper layer, ceria-Alumina (C) loaded with platinum, barium carbonate and magnesium carbonate, ceria loaded with palladium (B), palladium loaded zeolite (D), platinum, barium carbonate and carbonate contained in the lower layer. WO2014080373 A2 refers to a method for controlling the emission of polluting substances in a gaseous effluent produced by a combustion process comprising at least the step of putting said gaseous effluent, at a temperature within the range of 800° C.-1400° C., in contact with a sorbent composition in powder form comprising at least calcium hydroxide (Ca(OH)₂), magnesium hydroxide (Mg(OH)₂) and magnesium oxide (MgO), said sorbent having a specific surface area (BET) greater than 20 m²/g.

However, there is still a need in the art for processes for reducing the concentration of nitrogen oxides in gaseous and/or aerosol media, which provide an improved capability for adsorbing nitrogen oxides (NOₓ) from the environment and increased efficiency.

It is thus an object of the present invention to provide a process for taking up nitrogen oxides from a gaseous and/or aerosol medium. Another object may also be seen in the provision of a process for taking up nitrogen oxides from a gaseous and/or aerosol medium that effectively decreases the amount of nitrogen oxides in such a medium. Another object may also be seen in the provision of a process for taking up nitrogen oxides from a gaseous and/or aerosol medium providing a higher efficiency in taking up nitrogen oxides from such a medium than existing materials. A further object may be seen in the provision of a process for taking up nitrogen oxides from a gaseous and/or aerosol medium replacing or reducing the use of materials based on TiO₂. A further object may be seen in the provision of a process for taking up nitrogen oxides from a gaseous and/or aerosol medium enabling a low overall energy consumption for the process and corresponding installation. A still further object may be seen in the provision of a process for taking up nitrogen oxides from a gaseous and/or aerosol medium enabling increasing the efficiency of such a process, especially as regards time and the consumption of chemicals.

One or more of the foregoing and other problems are solved by the subject-matter as defined herein in the independent claims. Advantageous embodiments of the present invention are defined in the corresponding sub-claims.

According to one aspect of the present application a process for taking up one or more nitrogen oxide(s) from a medium is provided. The process comprising, more preferably consisting of the following steps:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g, and
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C.

It should be understood that for the purposes of the present invention, the following terms have the following meanings:

The term “taking up” or “uptake” in the meaning of the present invention refers to, but is not limited to, adsorbing, picking up, and/or assimilating physically and/or chemically and/or reacting one or more nitrogen oxide(s) onto the surface and/or into the pores and/or with molecules located on the surface and/or in the pores of the magnesium ion-comprising material such that the surface and/or pores and/or molecules located on the surface and/or in the pores of the particulate magnesium ion-comprising material is/are at least partially in contact with the one or more nitrogen oxide(s) or reaction products thereof.

The term “nitrogen oxide(s)”, i.e. nitrogen oxide or nitrogen oxides, refers to compounds comprising nitrogen oxide(s) or which may be obtained by the reaction of a nitrogen oxide with water, e.g. air humidity. Thus, the term “nitrogen oxide(s)” preferably comprises compounds selected from the group comprising NO, NO₂, NO₂⁻, NO₃⁻, N₂O, N₄O, N₂O₃, N₂O₄, N₂O₅, N₄O₆, and mixtures thereof.

The term “gaseous medium” in the meaning of the present invention refers to a medium that exists in a gaseous or vapour state, especially in a temperature range from −10 to +150° C.

The term “aerosol” in the meaning of the present invention refers to a medium that comprises a colloid of fine solid particles and/or liquid droplets, in air or another gas such as fog, particulate air pollutants and smoke. Especially in a temperature range from −10 to +150° C.

The term “magnesium ion-comprising material” refers to a material that comprises at least 40.0 wt.-% of a magnesium compound, based on the total dry weight of the magnesium ion-comprising material. Preferably, the material comprises at least 60.0 wt.-% and more preferably at least 80.0 wt.-% most preferably 90 to 100 wt.-% of a magnesium compound, based on the total dry weight of the magnesium ion-comprising material.

The “specific surface area” (expressed in m²/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 30 min prior to measurement. The total surface area (in m²) of said material can be obtained by multiplication of the specific surface area (in m²/g) and the mass (in g) of the material.

The term “dry” particulate material refers to a material of which 10 g have been heated in an oven at 150° C. until the mass is constant for at least 1 hour. The mass loss is expressed as wt.-% loss based on the initial material mass. This mass loss has been attributed to the material humidity.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Terms like “obtainable” or “definable” and “obtained” or “defined” are used interchangeably. This e.g. means that, unless the context clearly dictates otherwise, the term “obtained” does not mean to indicate that e.g. an embodiment must be obtained by e.g. the sequence of steps following the term “obtained” even though such a limited understanding is always included by the terms “obtained” or “defined” as a preferred embodiment.

According to another aspect of the present invention, a particulate magnesium ion-comprising material obtained by a process for taking up one or more nitrogen oxide(s) from a gaseous and/or aerosol medium as defined herein is provided.

According to a further aspect of the present invention, an adsorbing material comprising at least one particulate magnesium ion-comprising material having a BET specific surface area as measured by the BET nitrogen method in the range from 4 to 400 m²/g as defined herein is provided.

According to still a further aspect of the present invention, the use of at least one particulate magnesium ion-comprising material having a BET specific surface area as measured by the BET nitrogen method in the range from 4 to 400 m²/g as defined herein for taking up one or more nitrogen oxide(s) from a gaseous and/or aerosol medium is provided. It is preferred that the gaseous and/or aerosol medium comprises one or more nitrogen oxides selected from the group comprising NO, NO₂, NO₂⁻, NO₃⁻, N₂O, N₄O, N₂O₃, N₂O₄, N₂O₅, N₄O₆ and mixtures thereof, more preferably the one or more nitrogen oxide(s) is/are selected from NO and NO₂. In one embodiment, the at least one particulate magnesium ion-comprising material is in form of a powder, pellets, granulated powder, suspension, such as aqueous suspension or suspension in organic solvents, column, cartridge, paint, coating, filter material, gabions, preferably gabions placed next to a motorway or a waste incineration plant, building material.

According to one embodiment of the present process, the gaseous and/or aerosol medium of step a) is selected from the group comprising air, ambient air, exhaust fumes, factory fumes, household fumes, industrial fumes, vehicle exhausts, fog, smoke and mixtures thereof.

According to another embodiment of the present process, the gaseous and/or aerosol medium comprises one or more nitrogen oxide(s) selected from the group comprising NO, NO₂, NO₂⁻, NO₃⁻, N₂O, N₄O, N₂O₃, N₂O₄, N₂O₅, N₄O₆, and mixtures thereof, preferably one or more nitrogen oxides selected from NO and NO₂.

According to yet another embodiment of the present process, the gaseous and/or aerosol medium comprises the one or more nitrogen oxide(s) with partial pressures of up to 200 mbar, preferably of up to 100 mbar and more preferably with partial pressures ranging from 0.1 to 100 mbar.

According to one embodiment of the present process, the at least one particulate magnesium ion-comprising material of step b) is provided in form of a powder, pellets, granulated powder, suspension, such as aqueous suspension or suspension in organic solvents, column, cartridge, paint, coating, filter material, gabions, preferably gabions placed next to a motorway or a waste incineration plant, building material.

According to another embodiment of the present process, the at least on particulate magnesium ion-comprising material of step b) is selected from the group comprising a magnesium hydroxide-comprising material, a magnesium carbonate-comprising material, a magnesium oxide-comprising material and mixtures thereof, preferably the at least one particulate magnesium ion-comprising material of step b) is selected from the group comprising natural and precipitated hydromagnesite, preferably precipitated hydromagnesite, upsalite, magnesite, dolomite, half-burned dolomite, natural and synthetic magnesium oxide and natural and synthetic magnesium hydroxide.

According to yet another embodiment of the present process, the at least one particulate magnesium ion-comprising material of step b) has i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and/or ii) a BET specific surface area as measured by the BET nitrogen method of from 4 to 200 m²/g, more preferably of from 6 to 175 m²/g and most preferably of from 8 to 100 m²/g, and/or iii) a particle size distribution d₉₈/d₅₀ of ≥2, more preferably ≥3, preferably in the range from 3.2 to 8.0, determined by laser diffraction.

According to one embodiment of the present process, the at least one particulate magnesium ion-comprising material of step b) has a moisture content of at least 0.001 mg/m².

According to another embodiment of the present process, contacting step c) is carried out at a temperature ranging from 0 to +80° C. and most preferably from +10 to +55° C.

According to yet another embodiment of the present process, the process comprises a further step d) of washing the at least one particulate magnesium ion-comprising material obtained in step c) in one or more steps such as to remove the one or more nitrogen oxide(s) and/or reaction products thereof from the surface and/or from the pores of the at least one particulate magnesium ion-comprising material.

According to one embodiment of the present process, washing step d) is carried out by contacting the at least one particulate magnesium ion-comprising material obtained in step c) with water, an organic solvent, or mixtures thereof.

According to another embodiment of the present process, the at least one particulate magnesium ion-comprising material obtained in washing step d) is re-used in process step b) as the at least one particulate magnesium ion-comprising material.

As set out above, the inventive process for adsorbing one or more nitrogen oxide(s) from a gaseous and/or aerosol medium comprises the steps a), b) and c) and optionally step d). In the following, it is referred to further details of the present invention and especially the foregoing steps of the inventive process for adsorbing one or more nitrogen oxide(s) from a gaseous and/or aerosol medium. Those skilled in the art will understand that many embodiments described herein can be combined or applied together.

Characterisation of Step a): Provision of a Gaseous and/or Aerosol Medium

According to step a) of the process of the present invention, a gaseous and/or aerosol medium comprising one or more nitrogen oxide(s) is provided.

The term “one or more” nitrogen oxide(s) in the meaning of the present invention means that the nitrogen oxide comprises, preferably consists of, one or more kinds of nitrogen oxide(s).

In one embodiment of the present invention, the one or more nitrogen oxide(s) comprises, preferably consists of, one kind of nitrogen oxide. Alternatively, the one or more nitrogen oxide(s) comprises, preferably consists of, two or more kinds of nitrogen oxides. For example, the one or more nitrogen oxide(s) comprises, preferably consists of, two or three or four kinds of nitrogen oxides.

It is appreciated that the gaseous and/or aerosol medium provided in step a) of the instant process can be any gaseous and/or aerosol medium as long as it comprises one or more nitrogen oxide(s). Thus, the gaseous and/or aerosol medium provided in step a) of the instant process can be any natural or artificial gaseous and/or aerosol medium comprising one or more nitrogen oxide(s).

The gaseous and/or aerosol medium of step a) is preferably a medium selected from the group comprising air, ambient air, exhaust fumes, factory fumes, household fumes, industrial fumes, vehicle exhausts, fog, smoke and mixtures thereof.

In one embodiment, the gaseous and/or aerosol medium is a medium comprising an acid having an excess of NO₂ and/or NO₃. It is to be noted that the gaseous and/or aerosol medium preferably comprises an aqueous phase having an acidic pH, i.e. the pH must be below 7, preferably below 6.

In one embodiment of the present invention, the gaseous and/or aerosol medium comprises nitrogen oxides selected from the group comprising NO, NO₂, NO₂⁻, NO₃⁻, N₂O, N₄O, N₂O₃, N₂O₄, N₂O₅, N₄O₆, and mixtures thereof.

It is appreciated that the gaseous and/or aerosol medium preferably comprises a mixture of nitrogen oxides. For example, the gaseous and/or aerosol medium preferably comprises two or more compounds selected from the group comprising NO, NO₂, NO₂⁻, NO₃⁻, N₂O, N₄O, N₂O₃, N₂O₄, N₂O₅ and N₄O₆.

In one embodiment of the present invention, the gaseous and/or aerosol medium comprises NO and/or NO₂ as nitrogen oxides. For example, the gaseous and/or aerosol medium comprises nitrogen oxides consisting of NO and/or NO₂. Alternatively, the gaseous and/or aerosol medium comprises nitrogen oxides comprising, preferably consisting of, NO and/or NO₂ and one or more further nitrogen oxide(s) selected from the group comprising NO₂, NO₃, N₂O, N₄O, N₂O₃, N₂O₄, N₂O₅ and N₄O₆.

The gaseous and/or aerosol medium may comprise the one or more nitrogen oxide(s) in any amount. However, in order to obtain a sufficient uptaking of the nitrogen oxide(s) in the process of the present invention, it is preferred that the gaseous and/or aerosol medium comprises the one or more nitrogen oxide(s) with partial pressures of up to 200 mbar. For example, the gaseous and/or aerosol medium comprises the one or more nitrogen oxide(s) with partial pressures of up to 100 mbar and more preferably with partial pressures ranging from 0.1 to 100 mbar.

### Characterisation of Step b): Provision of at Least One Particulate Magnesium Ion-Comprising Material

According to step b) of the process of the present invention, at least one particulate magnesium ion-comprising material is provided.

It is appreciated that the expression “at least one” particulate magnesium ion-comprising material means that one or more kinds of particulate magnesium ion-comprising materials can be provided in the process of the present invention.

Accordingly, it should be noted that the at least one particulate magnesium ion-comprising material can be one kind of a particulate magnesium ion-comprising material.

Alternatively, the at least one particulate magnesium ion-comprising material can be a mixture of two or more kinds of particulate magnesium ion-comprising materials. For example, the at least one particulate magnesium ion-comprising material can be a mixture of two or three kinds of particulate magnesium ion-comprising materials, like two kinds of particulate magnesium ion-comprising materials.

In a preferred embodiment of the present invention, the at least one magnesium ion-comprising material is one kind of a particulate magnesium ion-comprising material.

For example, the at least one particulate magnesium ion-comprising material is selected from the group comprising a magnesium hydroxide-comprising material, a magnesium carbonate-comprising material, a magnesium oxide-comprising material and mixtures thereof. Preferably, the at least one particulate magnesium ion-comprising material is a magnesium hydroxide-comprising material and/or a magnesium carbonate-comprising material. More preferably, the at least one particulate magnesium ion-comprising material is a magnesium carbonate-comprising material.

In one embodiment, the at least one particulate magnesium ion-comprising material of step b) is selected from the group comprising, preferably consisting of, natural and precipitated hydromagnesite, preferably precipitated hydromagnesite, upsalite, magnesite, dolomite, half-burned dolomite, natural and synthetic magnesium oxide and natural and synthetic magnesium hydroxide. Preferably, the at least one particulate magnesium ion-comprising material of step b) is selected from the group comprising, preferably consisting of, natural and precipitated hydromagnesite, preferably precipitated hydromagnesite and natural magnesium hydroxide (brucite). For example, the at least one particulate magnesium ion-comprising material of step b) is natural or precipitated hydromagnesite, preferably precipitated hydromagnesite. Alternatively, the at least one particulate magnesium ion-comprising material of step b) is natural magnesium hydroxide (brucite).

Most preferably, the at least one particulate magnesium ion-comprising material of step b) is natural magnesium hydroxide (brucite).

“Hydromagnesite” or basic magnesium carbonate, which is the standard industrial name for hydromagnesite, is a naturally occurring mineral which is found in magnesium rich minerals such as serpentine and altered magnesium rich igneous rocks, but also as an alteration product of brucite in periclase marbles. Hydromagnesite has the chemical composition of Mg₅(CO₃)₄(OH)₂·4H₂O. It should be appreciated that hydromagnesite is a very specific mineral form of magnesium carbonate and occurs naturally as small needle-like crystals or crusts of acicular or bladed crystals. Besides the natural hydromagnesite, synthetic hydromagnesite (also called precipitated hydromagnesite or precipitated magnesium carbonate) can be also prepared.

“Upsalite” in the meaning of the present invention is a synthetic X-ray amorphous magnesium carbonate (MgCO₃) having a specifically high BET specific surface area. Preferably, upsalite has a BET specific surface area as measured by the BET nitrogen method of at least 60 m²/g, more preferably in the range from 60 to 800 m²/g. Upsalite is further described in WO2014087355 A1, which is thus herewith incorporated by reference.

“Magnesite” in the meaning of the present invention is a magnesium carbonate (MgCO₃) and naturally occurs in magnesium rich rock types.

“Dolomite” in the meaning of the present invention is a carbonatic calcium-magnesium-mineral having the chemical composition of CaMg(CO₃)₂ (“CaCO₃·MgCO₃”). Dolomite mineral contains at least 40.0 wt.-%, typically from 45.0 to 46.0 wt.-% MgCO₃. “Half-burned dolomite” is a dolomite which has been subjected to a high-temperature heat treatment at about 8000 by which the chemical composition alters by driving off carbon dioxide. Such material and corresponding production methods are well known in the art.

“Magnesium oxide” (MgO) may be also called “magnesia” and naturally occurs in magnesium rich rock types (“natural magnesium oxide”). Magnesium oxide may be also synthetically prepared (“synthetic magnesium oxide”). For example, the synthetic magnesium oxide can be caustic calcined magnesium oxide (or “caustic calcined magnesia”) which is prepared by calcining or burning crude magnesite at temperatures of <1000° C. Such material and corresponding production methods are well known in the art.

“Natural magnesium hydroxide” may be also called “brucite” which is a naturally occurring mineral being found in quartz-containing dolomite marble. Brucite has the chemical formula Mg(OH)₂. “Synthetic magnesium hydroxide” can be produced by hydrating magnesium oxide. Such material and corresponding production methods are well known in the art.

In one embodiment, the at least one particulate magnesium ion-comprising material of step b) is not provided in admixture with surface-modified calcium carbonate. Moreover, it is to be noted that surface-modified calcium carbonate is not added and thus not used in the process of the present invention.

“Surface-modified calcium carbonate” is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source.

It is preferred that the at least one particulate magnesium ion-comprising material of step b) is the only material used for taking up one or more nitrogen oxide(s) from a medium in the process of the present invention. Thus, the at least one particulate magnesium ion-comprising material of step b) is preferably not provided in admixture with other materials. Moreover, it is to be noted that such other materials are not added and thus not used in the process of the present invention.

For example, the at least one particulate magnesium ion-comprising material of step b) is not provided in admixture with a compound of a transition element, preferably a compound of a transition element selected from the group Pt, Rh, Pd, Ag, Ru, Os, Ir, V, Cr, Mn, Fe, Co, Ni and Cu, an oxide thereof, and a halide thereof, more preferably a zeolite carrying at least one of a compound of a transition element selected from the group Pt, Rh, Pd, Ag, Ru, Os, Ir, V, Cr, Mn, Fe, Co, Ni and Cu, an oxide thereof, and a halide thereof

Additionally or alternatively, the at least one particulate magnesium ion-comprising material of step b) is not provided in admixture with a nobel metal element, preferably a ceria-alumina supporting magnesium; zirconia-based composite oxide supporting rhodium; ceria-alumina loaded with platinum, barium carbonate and magnesium carbonate; ceria loaded with palladium, palladium loaded zeolite, platinum, barium carbonate and carbonate and mixtures thereof. For example, the at least one particulate magnesium ion-comprising material of step b) is not provided in admixture with barium carbonate and/or magnesium carbonate that are supported on ceria-alumina and ceria-alumina.

Additionally or alternatively, the at least one particulate magnesium ion-comprising material of step b) is not provided in admixture with or in the form of a sorbent composition comprising at least calcium hydroxide (Ca(OH)₂), magnesium hydroxide (Mg(OH)₂) and magnesium oxide (MgO) or a (activated) sorbent comprising calcium oxide (CaO) and magnesium oxide (MgO). For example, the at least one particulate magnesium ion-comprising material of step b) is not provided in admixture with calcium hydroxide (Ca(OH)₂) and/or calcium oxide (CaO).

It is one specific requirement of the present process that the at least one particulate magnesium ion-comprising material has a BET specific surface area as measured by the BET nitrogen method in the range from 4 to 400 m²/g. This is advantageous as it is assumed that a large surface area makes it possible for taking up the one or more nitrogen oxide(s) more efficiently on the surface and/or in the pores of the particles. Preferably, the at least one particulate magnesium ion-comprising material has a BET specific surface area as measured by the BET nitrogen method of from 4 to 200 m²/g, more preferably of from 6 to 175 m²/g and most preferably of from 8 to 100 m²/g.

The particulate magnesium ion-comprising material of step b) preferably has a volume median particle size d₅₀ of <30 mm, more preferably from 40 nm to 2 000 μm and most preferably from 60 nm to 400 μm.

In a preferred embodiment, the particulate magnesium ion-comprising material of step b) has a volume median particle size d₅₀ from 1 to 100 μm, preferably from 1.5 to 50 μm, more preferably from 1.7 to 30 μm and most preferably from 1.9 to 20 μm. For example, the particulate magnesium ion-comprising material of step b) has a volume median particle size d₅₀ from 1.9 to 10 μm or from 1.9 to 4.5 μm.

Additionally or alternatively, the at least one particulate magnesium ion-comprising material of step b) preferably has a particle size distribution d₉₈/d₅₀ of ≥2, more preferably ≥3, preferably in the range from 3.2 to 8.0, determined by laser diffraction. If not otherwise indicated, the particle size distribution d₉₈/d₅₀ of the at least one particulate magnesium ion-comprising material is volume based, i.e. d₉₈ (vol)/d₅₀ (vol).

The value dₓ represents the diameter relative to which x % of the particles have diameters less than dₓ. This means that the d₉₈ value is the particle size at which 98% of all particles are smaller. The d₉₈ value is also designated as “top cut”. The dₓ values may be given in volume or weight percent. The d₅₀ (wt) value is thus the weight median particle size, i.e. 50 wt % of all grains are smaller than this particle size, and the d₅₀ (vol) value is the volume median particle size, i.e. 50 vol. % of all grains are smaller than this particle size.

Thus, the at least one particulate magnesium ion-comprising material of step b) preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and/or
ii) a BET specific surface area as measured by the BET nitrogen method of from 4 to 200 m²/g, more preferably of from 6 to 175 m²/g and most preferably of from 8 to 100 m²/g, and/or a particle size distribution d₉₈/d₅₀ of ≥2, more preferably ≥3, preferably in the range from 3.2 to 8.0, determined by laser diffraction.

For example, the at least one particulate magnesium ion-comprising material of step b) preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, or
ii) a BET specific surface area as measured by the BET nitrogen method of from 4 to 200 m²/g, more preferably of from 6 to 175 m²/g and most preferably of from 8 to 100 m²/g, or
a particle size distribution d₉₈/d₅₀ of ≥2, more preferably ≥3, preferably in the range from 3.2 to 8.0, determined by laser diffraction.

Alternatively, the at least one particulate magnesium ion-comprising material of step b) preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and
ii) a BET specific surface area as measured by the BET nitrogen method of from 4 to 200 m²/g, more preferably of from 6 to 175 m²/g and most preferably of from 8 to 100 m²/g, and
iii) a particle size distribution d₉₈/d₅₀ of ≥2, more preferably ≥3, preferably in the range from 3.2 to 8.0, determined by laser diffraction.

It is specifically preferred that the at least one particulate magnesium ion-comprising material of step b) preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and/or
ii) a particle size distribution d₉₈/d₅₀ of ≥2, more preferably ≥3, preferably in the range from 3.2 to 8.0, determined by laser diffraction.

For example, the at least one particulate magnesium ion-comprising material of step b) preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, or
ii) a particle size distribution d₉₈/d₅₀ of ≥2, more preferably ≥3, preferably in the range from 3.2 to 8.0, determined by laser diffraction.

Alternatively, the at least one particulate magnesium ion-comprising material of step b) preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and
ii) a particle size distribution d₉₈/d₅₀ of ≥2, more preferably ≥3, preferably in the range from 3.2 to 8.0, determined by laser diffraction.

Volume median grain diameter d₅₀ was evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The processes and instruments are known to the skilled person and are commonly used to determine grain size of fillers and pigments.

In one embodiment, the at least one particulate magnesium ion-comprising material of step b) has a moisture content of at least 0.001 mg/m². Additionally or alternatively, the at least one particulate magnesium ion-comprising material of step b) has a moisture content of at most 2.0 mg/m². For example, the at least one magnesium ion-comprising material of step b) has a moisture content in the range from 0.001 to 2.0 mg/m².

The at least one particulate magnesium ion-comprising material of step b) can be provided in any form, especially in any form which is suitable for exposing a large surface area to the one or more nitrogen oxide(s) which is/are present in the gaseous and/or aerosol medium.

Thus, the at least one particulate magnesium ion-comprising material of step b) is preferably provided in form of a powder, pellets, granulated powder, suspension such as aqueous suspension or suspension in organic solvents, column, cartridge, paint, coating, filter material, gabions, preferably gabions placed next to a motorway or a waste incineration plant, building material.

In one embodiment, the at least one particulate magnesium ion-comprising material of step b) is preferably provided in form of pellets consisting of the at least one particulate magnesium ion-comprising material and a binder. It is appreciated that the binder may be any binder known to the skilled person and typically used for the products to be prepared.

Preferably, the binder is an organic binder. For example, the binder is an organic binder selected from the group comprising modified cellulose gums, polyvinylpyrrolidones, sodium carboxymethyl starch, alginates, microcrystalline cellulose and its polymorphic forms, agar, gelatine, dextrines, acrylic acid polymers, carboxymethyl cellulose, carboxymethyl cellulose sodium/calcium, hydroxpropyl methyl cellulose phthalate, and mixtures thereof. Preferably, the organic binder is carboxymethyl cellulose.

In one embodiment, the at least one particulate magnesium ion-comprising material of step b) is preferably provided in form of a coating consisting of the at least one particulate magnesium ion-comprising material and a binder. It is appreciated that the binder may be any binder known to the skilled person and typically used for the products to be prepared. Preferably, the binder is an organic binder.

Characterisation of Step c): Contacting the Gaseous and/or Aerosol Medium with the at Least One Particulate Magnesium Ion-Comprising Material

According to step c) of the process of the present invention, the gaseous and/or aerosol medium of step a) is contacted with the at least one particulate magnesium ion-comprising material of step b) in any order, taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C.

In general, the gaseous and/or aerosol medium of step a) and the at least one particulate magnesium ion-comprising material of step b) can be brought into contact by any conventional means known to the skilled person.

For example, contacting step c) is carried out by passing the gaseous and/or aerosol medium of step a) through the at least one particulate magnesium ion-comprising material of step b). This embodiment is especially preferred if the at least one particulate magnesium ion-comprising material is provided in form of a powder, pellets, granulated powder and/or suspension such as aqueous suspension or suspension in organic solvents, column, cartridge, or filter material. For example, the organic solvent may be selected from the group comprising methanol, ethanol, acetone, acetonitrile, tetrahydrofuran, toluene, benzene, diethyl ether, petroleum ether, dimethylsulphoxide and mixtures thereof.

Additionally or alternatively, contacting step c) is carried out by passing the gaseous and/or aerosol medium of step a) over the at least one particulate magnesium ion-comprising material of step b). This embodiment is especially preferred if the at least one particulate magnesium ion-comprising material is provided in form of a paint, coating, filter material, building material, powder, pellets, granulated powder and/or suspension such as aqueous suspension or suspension in organic solvents.

Thus, the step of contacting the at least one particulate magnesium ion-comprising material of step b) with the gaseous and/or aerosol medium of step a) is preferably achieved by the gas flow of the gaseous and/or aerosol medium.

It is appreciated that the gaseous and/or aerosol medium of step a) is contacted with the at least one particulate magnesium ion-comprising material of step b) at a concentration and for a time sufficient for taking up at least a part of the one or more nitrogen oxide(s) from the gaseous and/or aerosol medium onto the surface and/or into the pores of the at least one particulate magnesium ion-comprising material.

In general, the amount of the at least one magnesium ion-comprising material of step b) for taking up the one or more nitrogen oxide(s) from the gaseous and/or aerosol medium may vary depending on the nitrogen oxide(s) content in the gaseous and/or aerosol medium, the gas flow applied and the at least one particulate magnesium ion-comprising material used.

It is appreciated that contacting step c) is carried out for a time sufficient for taking up at least a part of the one or more nitrogen oxide(s) from the gaseous and/or aerosol medium onto the surface and/or into the pores of the at least one particulate magnesium ion-comprising material.

In one embodiment, the contacting is carried out for a time such that no further decrease of the nitrogen oxide(s) amount in the gaseous and/or aerosol medium is detected. This is preferably the case if the contacting is carried out in a batch process. The contacting time may be empirically determined using common methods known to the skilled person or described in the present application.

For example, a sufficient time for contacting the gaseous and/or aerosol medium of step a) with the at least one particulate magnesium ion-comprising material of step b) is in the range from 0.1 milliseconds to 1 year, preferably in the range from 1 millisecond to 9 months, more preferably in the range from 2 milliseconds to 6 months, and most preferably in the range from 3 milliseconds to 3 months. In one embodiment, a sufficient time for contacting the gaseous and/or aerosol medium of step a) with the at least one particulate magnesium ion-comprising material of step b) is in the range from 0.1 milliseconds to 4 weeks, preferably in the range from 1 millisecond to 3 weeks, more preferably in the range from 2 milliseconds to 1 day, and most preferably in the range from 3 milliseconds to 1 hour. The contacting typically starts when the at least one particulate magnesium ion-comprising material of step b) is thoroughly covered with the gaseous and/or aerosol medium of step a).

It is appreciated that contacting step c) can be repeated one or more times.

Alternatively, contacting step c) is carried out in a continuous process.

It is appreciated that contacting step c) is carried out at a temperature ranging from −10 to +150° C., preferably from 0 to +80° C. and most preferably from +10 to +55° C.

The gaseous and/or aerosol medium obtained in step c) preferably has a nitrogen oxide content below the nitrogen oxide content of the gaseous and/or aerosol medium provided in step a).

### Optional Steps

It is appreciated that the process for taking up one or more nitrogen oxide(s) from a medium may comprise a further step of exposing the at least one particulate magnesium ion-comprising material of step b) to visible light during and/or after step c). Such a step of exposing the at least one particulate magnesium ion-comprising material of step b) to visible light may be carried out during contacting step c). Alternatively, this step is carried out after contacting step c).

Accordingly, steps c) and the step of exposing the at least one particulate magnesium ion-comprising material of step b) to visible light are carried out simultaneously, or separately in the given order. For example, steps c) and the step of exposing the at least one particulate magnesium ion-comprising material of step b) to visible light are carried out separately in the given order, i.e. the step of exposing the at least one particulate magnesium ion-comprising material of step b) to visible light is carried out after step c). Alternatively, steps c) and the step of exposing the at least one particulate magnesium ion-comprising material of step b) to visible light are carried out simultaneously.

It is appreciated that the step of exposing the at least one particulate magnesium ion-comprising material of step b) to visible light can be repeated one or more times.

It is appreciated that the step of exposing the at least one particulate magnesium ion-comprising material of step b) to visible light can be carried by any means known to the skilled person which is suitable for exposing the at least one particulate magnesium ion-comprising material of step b) to visible light.

For example, such visible light exposing step can be achieved by a corresponding lamp.

The step of exposing the at least one particulate magnesium ion-comprising material of step b) to visible light can be carried out in a batch or continuous process. Preferably, the step of exposing the at least one particulate magnesium ion-comprising material of step b) to visible light is carried out in a continuous process.

In one embodiment, the process for taking up one or more nitrogen oxide(s) from a medium comprises a further step d) of washing the at least one particulate magnesium ion-comprising material obtained in step c) in one or more steps such as to remove the one or more nitrogen oxide(s) and/or reaction products thereof from the surface and/or from the pores of the at least one particulate magnesium ion-comprising material.

The term “reaction products” of the one or more nitrogen oxide(s) in the meaning of the present invention refers to products obtained by contacting at least one particulate magnesium ion-comprising material with one or more nitrogen oxide(s). Said reaction products are formed between the one or more nitrogen oxide(s) and reactive molecules, for example water molecules, located at the surface of the at least one particulate magnesium ion-comprising material.

Step d) is specifically advantageous as the at least one particulate magnesium ion-comprising material obtained in step d) can be re-used as the at least one particulate magnesium ion-comprising material of step b). Thus, this step severely reduces the consumption of adsorbent and thus this step is suitable for increasing the overall efficiency, especially as regards the consumption of chemicals, of the inventive process.

In view of this, step d) is carried out after contacting step c).

Accordingly, steps c) and d) are carried out separately in the given order, i.e. step d) is carried out after step c).

It is appreciated that step d) can be repeated one or more times.

It is appreciated that washing step d) can be carried out by any means known to the skilled person which is suitable for removing one or more nitrogen oxide(s) and reaction products thereof from the surface and/or from the pores of the at least one particulate magnesium ion-comprising material.

For example, washing step d) is carried out by contacting the at least one particulate magnesium ion-comprising material obtained in step c) with water, an organic solvent or mixtures thereof.

The organic solvent preferably comprises, more preferably consists of, a water-immiscible solvent. For example, the water-immiscible solvent may be selected from the group comprising toluene, benzene, diethyl ether, petroleum ether, dimethylsulphoxide and mixtures thereof. In one embodiment, the organic solvent comprises the water-immiscible solvent in an amount of at least 90.0 wt.-%, preferably at least 92.0 wt.-%, more preferably at least 94.0 wt.-%, even more preferably at least 96.0 wt.-% and most preferably at least 98.0 wt.-%, e.g. at least 99.0 wt.-%, based on the total weight of the organic solvent. For example, the organic solvent consists of the water-immiscible solvent.

Alternatively, the organic solvent is a water-miscible solvent. For example, the organic solvent may be selected from the group comprising methanol, ethanol, acetone and mixtures thereof.

In one embodiment, washing step d) is carried out by contacting the at least one particulate magnesium ion-comprising material obtained in step c) with a mixture of water and an organic solvent. In this embodiment, the organic solvent may be selected from the group comprising methanol, ethanol, acetone, acetonitrile, tetrahydrofuran, toluene, benzene, diethyl ether, petroleum ether, dimethylsulphoxide and mixtures thereof. Preferably, the mixture of water and organic solvent comprises water in an amount of from 50.0 to 99.0 wt.-%, preferably from 60.0 to 98.0 wt.-%, more preferably from 70.0 to 97.0 wt.-%, based on the total weight of the mixture.

Preferably, the washing step d) is carried out by contacting the at least one particulate magnesium ion-comprising material obtained in step c) with water.

As already mentioned above, step d) is advantageous as the at least one particulate magnesium ion-comprising material obtained in step d) can be re-used as the at least one particulate magnesium ion-comprising material of step b).

It is thus appreciated that the at least one particulate magnesium ion-comprising material obtained in washing step d) can be re-used in process step b) as the at least one particulate magnesium ion-comprising material.

Thus, the process for taking up one or more nitrogen oxide(s) from a medium may comprise a further step e) of re-using the at least one particulate magnesium ion-comprising material obtained in washing step d) in process step b) as the at least one particulate magnesium ion-comprising material.

In one preferred embodiment, the process for taking up one or more nitrogen oxide(s) from a medium thus preferably comprises, more preferably consists of, the following steps:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g,
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C., and
d) washing the at least one particulate magnesium ion-comprising material obtained in step c) in one or more steps such as to remove the one or more nitrogen oxide(s) and reaction products thereof from the surface and/or from the pores of the at least one particulate magnesium ion-comprising material.

Alternatively, the process for taking up one or more nitrogen oxide(s) from a medium comprises, more preferably consists of, the following steps:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g,
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material,
d) washing the at least one particulate magnesium ion-comprising material obtained in step c) in one or more steps such as to remove the one or more nitrogen oxide(s) and reaction products thereof from the surface and/or from the pores of the at least one particulate magnesium ion-comprising material, and
e) re-using the at least one particulate magnesium ion-comprising material obtained in washing step d) in process step b) as the at least one particulate magnesium ion-comprising material.

The inventive process thus provides a number of improved properties. First of all, one or more nitrogen oxide(s) can be effectively taken up from a gaseous and/or aerosol medium, i.e. the process effectively decreases the amount of one or more nitrogen oxide(s) in a gaseous and/or aerosol medium. Furthermore, the use of at least one particulate magnesium ion-comprising material having a BET specific surface area as measured by the BET nitrogen method in the range from 4 to 400 m²/g in the inventive process provides a more efficient taking up of nitrogen oxide(s) compared to calcium ion-comprising materials, such as surface-modified calcium carbonate, used in the same process. Furthermore, the process can be carried out with a material replacing or reducing the use of materials based on TiO₂. In addition thereto, the process allows for lowering the overall energy consumption and for increasing the efficiency, especially as regards time and the consumption of chemicals.

In view of the very good results obtained, the present invention refers in a further aspect to a particulate magnesium ion-comprising material obtained by a process for taking up one or more nitrogen oxide(s) from a gaseous and/or aerosol medium as defined herein.

With regard to the definition of the process for taking up one or more nitrogen oxide(s) from a gaseous and/or aerosol medium and preferred embodiments thereof, reference is made to the statements provided above when discussing the technical details of the process of the present invention.

It is appreciated that the particulate magnesium ion-comprising material is obtained by a process for taking up one or more nitrogen oxide(s) from a medium comprising, more preferably consisting of, the following steps:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g, and
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C.

Alternatively, the particulate magnesium ion-comprising material is obtained by a process for taking up one or more nitrogen oxide(s) from a medium comprising, more preferably consisting of, the steps of:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g,
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C., and
d) washing the at least one particulate magnesium ion-comprising material obtained in step c) in one or more steps such as to remove the one or more nitrogen oxide(s) and reaction products thereof from the surface and/or from the pores of the at least one particulate magnesium ion-comprising material.

Thus, it is appreciated that the particulate magnesium ion-comprising material obtained by a process for taking up one or more nitrogen oxide(s) from a medium, as defined herein, comprises, preferably consists of, at least one particulate magnesium ion-comprising material and one or more nitrogen oxide(s) and/or reaction products thereof present on the surface and/or the pores of the at least one particulate magnesium ion-comprising material.

According to another aspect, the present invention refers to a particulate magnesium ion-comprising material, wherein one or more nitrogen oxide(s) are taken up onto the surface and/or into the pores of the particulate magnesium ion-comprising material.

With regard to the definition of the particulate magnesium ion-comprising material, the nitrogen oxide(s) and preferred embodiments thereof, reference is further made to the statements provided above when discussing the technical details of the process of the present invention.

According to a further aspect, the present invention refers to an adsorbing material comprising at least one particulate magnesium ion-comprising material having a BET specific surface area as measured by the BET nitrogen method in the range from 4 to 400 m²/g.

The at least one particulate magnesium ion-comprising material can be one kind of a particulate magnesium ion-comprising material. Alternatively, the at least one particulate magnesium ion-comprising material can be a mixture of two or more kinds of particulate magnesium ion-comprising materials. For example, the at least one particulate magnesium ion-comprising material can be a mixture of two or three kinds of particulate magnesium ion-comprising materials, like two kinds of particulate magnesium ion-comprising materials.

In a preferred embodiment of the present invention, the at least one magnesium ion-comprising material is one kind of a particulate magnesium ion-comprising material.

For example, the at least one particulate magnesium ion-comprising material is selected from the group comprising a magnesium hydroxide-comprising material, a magnesium carbonate-comprising material, a magnesium oxide-comprising material and mixtures thereof. Preferably, the at least one particulate magnesium ion-comprising material is a magnesium hydroxide-comprising material and/or a magnesium carbonate-comprising material. More preferably, the at least one particulate magnesium ion-comprising material is a magnesium carbonate-comprising material.

In one embodiment, the at least one particulate magnesium ion-comprising material is selected from the group comprising, preferably consisting of, natural and precipitated hydromagnesite, preferably precipitated hydromagnesite, upsalite, magnesite, dolomite, half-burned dolomite, natural and synthetic magnesium oxide and natural and synthetic magnesium hydroxide. Preferably, the at least one particulate magnesium ion-comprising material is selected from the group comprising, preferably consisting of, natural and precipitated hydromagnesite, preferably precipitated hydromagnesite, and natural magnesium hydroxide (brucite). For example, the at least one particulate magnesium ion-comprising material is natural or precipitated hydromagnesite, preferably precipitated hydromagnesite.

Alternatively, the at least one particulate magnesium ion-comprising material is natural magnesium hydroxide (brucite).

In one embodiment, the at least one particulate magnesium ion-comprising material is not in admixture with surface-modified calcium carbonate. Moreover, it is to be noted that surface-modified calcium carbonate is not added and thus not used into the process of the present invention.

It is one specific requirement of the present invention that the at least one particulate magnesium ion-comprising material has a BET specific surface area as measured by the BET nitrogen method in the range from 4 to 400 m²/g. This is advantageous as it is assumed that a large surface area, preferably in combination with a high intra-particle intruded specific pore volume, makes it possible for taking up the one or more nitrogen oxide(s) more efficiently on the surface and/or in the pores of the particles. Preferably, the at least one particulate magnesium ion-comprising material has a BET specific surface area as measured by the BET nitrogen method of from 4 to 200 m²/g, more preferably of from 6 to 175 m²/g and most preferably of from 8 to 100 m²/g.

The particulate magnesium ion-comprising material preferably has a volume median particle size d₅₀ of <30 mm, more preferably from 40 nm to 2 000 μm and most preferably from 60 nm to 400 μm, e.g. from 1.9 to 10 μm or from 1.9 to 4.5 μm.

Additionally or alternatively, the at least one particulate magnesium ion-comprising material preferably has a particle size distribution d₉₈/d₅₀ of ≥2, more preferably ≥3, preferably in the range from 3.2 to 8.0, determined by laser diffraction.

Thus, the at least one particulate magnesium ion-comprising material preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and/or
ii) a BET specific surface area as measured by the BET nitrogen method of from 4 to 200 m²/g, more preferably of from 6 to 175 m²/g and most preferably of from 8 to 100 m²/g, and/or
a particle size distribution d₉₈/d₅₀ of ≥2, more preferably ≥3, preferably in the range from 3.2 to 8.0, determined by laser diffraction.

For example, the at least one particulate magnesium ion-comprising material preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, or
ii) a BET specific surface area as measured by the BET nitrogen method of from 4 to 200 m²/g, more preferably of from 6 to 175 m²/g and most preferably of from 8 to 100 m²/g, or
a particle size distribution d₉₈/d₅₀ of ≥2, more preferably ≥3, preferably in the range from 3.2 to 8.0, determined by laser diffraction.

Alternatively, the at least one particulate magnesium ion-comprising material preferably has
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and
ii) a BET specific surface area as measured by the BET nitrogen method of from 4 to 200 m²/g, more preferably of from 6 to 175 m²/g and most preferably of from 8 to 100 m²/g, and
iii) a particle size distribution d₉₈/d₅₀ of ≥2, more preferably ≥3, preferably in the range from 3.2 to 8.0, determined by laser diffraction.

It is specifically preferred that the at least one particulate magnesium ion-comprising material preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and/or
ii) a particle size distribution d₉₈/d₅₀ of ≥2, more preferably ≥3, preferably in the range from 3.2 to 8.0, determined by laser diffraction.

For example, the at least one particulate magnesium ion-comprising material preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, or
ii) a particle size distribution d₉₈/d₅₀ of ≥2, more preferably ≥3, preferably in the range from 3.2 to 8.0, determined by laser diffraction.

Alternatively, the at least one particulate magnesium ion-comprising material preferably has a BET specific surface area as measured by the BET nitrogen method in the range from 4 to 400 m²/g, preferably of from 4 to 200 m²/g, more preferably of from 6 to 175 m²/g and most preferably of from 8 to 100 m²/g, and
i) a volume median particle size d₅₀ of <30 mm, more preferably from 40 nm to 2 000 μm and most preferably from 60 nm to 400 μm, e.g. from 1.9 to 10 μm or from 1.9 to 4.5 μm, determined by laser diffraction, and
ii) a particle size distribution d₉₈/d₅₀ of ≥2, more preferably ≥3, preferably in the range from 3.2 to 8.0, determined by laser diffraction.

The at least one particulate magnesium ion-comprising material features a specific intra-particle intruded specific pore volume which increases the particles' surface area such that the one or more nitrogen oxide(s) can be taken up more sufficiently on the particulate magnesium ion-comprising material particles. Preferably, the at least one particulate magnesium ion-comprising material has an intra-particle intruded specific pore volume from 0.150 to 1.300 cm³/g, and preferably from 0.178 to 1.244 cm³/g, calculated from a mercury intrusion porosimetry measurement.

The intra-particle pore size of the at least one particulate magnesium ion-comprising material is in a range of from 0.004 to 1.6 μm, more preferably in a range of from 0.005 to 1.3 μm, especially preferably from 0.006 to 1.15 μm and most preferably of 0.007 to 1.0 μm, determined by mercury porosimetry measurement.

In one embodiment, the at least one particulate magnesium ion-comprising material has a moisture content of at least 0.001 mg/m². For example, the at least one magnesium ion-comprising material has a moisture content in the range from 0.001 to 0.3 mg/m².

The at least one particulate magnesium ion-comprising material can be provided in any form, especially in any form which is suitable for exposing a large surface area to the one or more nitrogen oxide(s) which is/are present in the gaseous and/or aerosol medium.

Thus, the at least one particulate magnesium ion-comprising material is preferably provided in form of a powder, pellets, granulated powder, suspension such as aqueous suspension or suspension in organic solvents, column, cartridge, paint, coating, filter material, gabions, preferably gabions placed next to a motorway or a waste incineration plant, building material.

In one embodiment, the adsorbing material is in form of a powder, pellets, granulated powder, aqueous suspension, column, cartridge, paint, coating, filter material, gabions, preferably gabions placed next to a motorway or a waste incineration plant, building material and the like.

For example, the adsorbing material is in form of pellets consisting of the at least one particulate magnesium ion-comprising material and a binder, preferably an organic binder.

For example, the adsorbing material is in form of a coating consisting of the at least one particulate magnesium ion-comprising material and a binder, preferably an organic binder. For example, the binder is an organic binder selected from the group comprising modified cellulose gums, polyvinylpyrrolidones, sodium carboxymethyl starch, alginates, microcrystalline cellulose and its polymorphic forms, agar, gelatine, dextrines, acrylic acid polymers, carboxymethyl cellulose, carboxymethyl cellulose sodium/calcium, hydroxpropyl methyl cellulose phthalate, and mixtures thereof. Preferably, the organic binder is carboxymethyl cellulose.

In a preferred embodiment, the adsorbing material consists of the at least one particulate magnesium ion-comprising material having a BET specific surface area as measured by the BET nitrogen method in the range from 4 to 400 m²/g.

In particular, it is appreciated that the adsorbing material is suitable for taking up one or more nitrogen oxide(s) from a gaseous and/or aerosol medium.

With regard to the definition of the particulate magnesium ion-comprising material and preferred embodiments thereof, reference is further made to the statements provided above when discussing the technical details of the process of the present invention.

According to a still further aspect, the present invention refers to the use of at least one particulate magnesium ion-comprising material having a BET specific surface area as measured by the BET nitrogen method in the range from 4 to 400 m²/g for taking up one or more nitrogen oxide(s) from a gaseous and/or aerosol medium.

Preferably, preferably the gaseous and/or aerosol medium comprises one or more nitrogen oxides selected from the group comprising NO, NO₂, NO₂⁻, NO₃⁻, N₂O, N₄O, N₂O₃, N₂O₄, N₂O₅, N₄O₆ and mixtures thereof. More preferably, the one or more nitrogen oxide(s) is/are selected from NO and NO₂.

In one embodiment, the at least one particulate magnesium ion-comprising material is in form of a powder, pellets, granulated powder, suspension, such as aqueous suspension or suspension in organic solvents, column, cartridge, paint, coating, filter material, gabions, preferably gabions placed next to a motorway or a waste incineration plant, building material.

With regard to the definition of the particulate magnesium ion-comprising material and preferred embodiments thereof, reference is further made to the statements provided above when discussing the technical details of the process and the adsorbing material of the present invention.

### BRIEF DESCRIPTION OF THE FIGURES

FIG. 1 shows the adsorption of NO₂ for inventive magnesium ion-comprising materials compared to a calcium ion-comprising material.

FIG. 2 shows the adsorption of NO for inventive magnesium ion-comprising materials compared to a calcium ion-comprising material.

The scope and interest of the invention may be better understood on basis of the following examples which are intended to illustrate embodiments of the present invention. However, they are not to be construed to limit the scope of the claims in any manner whatsoever.

### EXAMPLES

### 1. Measurement Methods

In the following the measurement methods implemented in the examples are described.

### Particle Size Distribution of a Particulate Material:

Volume based median particle size d₅₀ (vol) and the volume based top cut particle size d₉₈ (vol) as well as the volume based particle size d₁₀ (vol) were evaluated in a wet unit using a Malvern Mastersizer 3000 Laser Diffraction System (Malvern Instruments Plc., Great Britain). The d₅₀ (vol), d₉₈ (vol) or d₁₀ (vol) value indicates a diameter value such that 50% or 98% or 10% by volume, respectively, of the particles have a diameter of less than this value. The raw data obtained by the measurement was analysed using the Mie theory, with a particle refractive index of 1.57 and an absorption index of 0.005. The methods and instruments are known to the skilled person and are commonly used to determine particle size distributions of fillers and pigments.

The weight based median particle size d₅₀ (wt) was measured by the sedimentation method, which is an analysis of sedimentation behaviour in a gravimetric field. The measurement was made with a Sedigraph™ 5100 or 5120 of Micromeritics Instrument Corporation, USA. The method and the instrument are known to the skilled person and are commonly used to determine particle size distributions of fillers and pigments. The measurement was carried out in an aqueous solution of 0.1 wt.-% Na₄P₂O₇. The samples were dispersed using a high speed stirrer and sonicated.

If not otherwise indicated in the following example section, the volume particle sizes were evaluated in a wet unit using a Malvern Mastersizer 3000 Laser Diffraction System (Malvern Instruments Plc., Great Britain).

### BET Specific Surface Area of a Particulate Material

Throughout the present document, the specific surface area (in m²/g) of the particulate material is determined using the BET method (using nitrogen as adsorbing gas), which is well known to the skilled man (ISO 9277:2010). The total surface area (in m²) of the particulate material is then obtained by multiplication of the specific surface area and the mass (in g) of the particulate material prior to treatment.

### Solids Content

The suspension solids content (also known as “dry weight”) was determined using a Moisture Analyser MJ33 from the company Mettler-Toledo, Switzerland, with the following settings: drying temperature of 150° C., automatic switch off if the mass does not change more than 1 mg over a period of 30 sec, standard drying of 5 to 20 g of suspension.

### Moisture Content (Humidity)

A 10 g powder sample has been heated in an oven at 150° C. until the mass is constant for at least 1 hour. The mass loss has been expressed as wt.-% loss based on the initial sample mass. This mass loss has been attributed to the sample humidity.

### 2. Examples

### 2.1 Materials Used

### NOₓ Gas

Synthetic air containing nitrogen dioxide was provided by Messer Schweiz AG (Switzerland). The indicated analytical value is 0.4 vol % of NO₂ (uncertainty +/−3%).

Nitrogen containing nitrogen monoxide was provided by Messer Schweiz AG (Switzerland). The indicated analytical value is 10 vol % of NO (uncertainty +/−2%).

### Hydromagnesite (Inventive Material)

The hydromagnesite was a precipitated hydromagnesite produced by Omya International AG based on published protocols (see e.g. M. Pohl, C. Rainer, M. Esser; Omya Development AG, EP2322581 A1). The hydromagnesite had a d₅₀ (vol)=3.2 μm, d₉₈ (vol)=12.4 μm, d₉₈ (vol)/d₅₀ (vol)=3.88, and a BET SSA=92.2 m²/g.

### Milled Natural Brucite (Inventive Material)

The milled natural brucite from Russia had a d₅₀ (vol)=1.98 μm, d₉₈ (vol)=14.3 μm, d₉₈ (vol)/d₅₀ (vol)=7.22, and a BET SSA=9.15 m²/g.

### SYNTHETIC Magnesium Hydroxide (Inventive Material)

The synthetic magnesium hydroxide was synthesized from sea water by precipitation and had a d₅₀ (vol)=4.86 μm, d₉₈ (vol)=15 μm, d₉₈ (vol)/d₅₀ (vol)=3.09, and a BET SSA=4.55 m²/g.

### Natural Ground Calcium Carbonate (Comparative Material)

The natural ground calcium carbonate was ground marble, which is commercially available from Omya International AG. The natural ground calcium carbonate had a d₅₀ (vol)=1.7 μm, d₉₈ (vol)=8 μm, d₉₈ (vol)/d₅₀ (vol)=4.71, and a BET SSA=3.75 m²/g.

### 2.2 NO₂ Adsorption

The adsorption experiments have been conducted using a Hiden Isochema IGA-002 gravimetric analyzer. The instrument allows to monitor changes in the gravimetrically determined mass of a sample exposed to a gas at controlled temperature and pressure. For the shown experiments a tainless steel TGA crucible with a volume of 120 μl (supplied by Mettler-Toledo (Schweiz) GmbH, Greifensee, Switzerland) was filled to the top with the respective sample powder of the materials described above. The crucible was mounted to the balance inside the instrument reaction chamber. The temperature in the sample chamber was controlled by a Thermostat at 20° C. during the whole experiment. The chamber was closed and pumped out to a vacuum of less than 5 mbar. After the vacuum was achieved the reaction chamber was filled with artificial air containing 0.4 vol % of NO₂ (supplied by Messer Schweiz AG, Lenzburg, Switzerland) at 100 mbar/min. The gravimetrical weight was monitored and the change was attributed to the adsorption of NO₂ and converted to adsorption rates based on time and sample weight for comparison purposes.

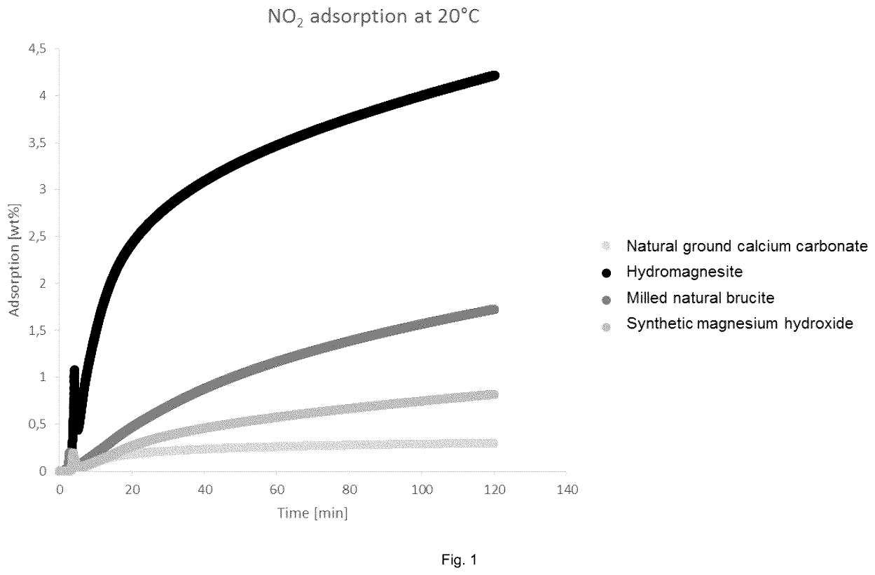

The results for the tested materials are shown in FIG. 1. It can be gathered from FIG. 1 that the particulate magnesium ion-comprising material according to the present invention shows a higher adsorption for NO₂ than the comparative material based on calcium carbonate, i.e. a calcium ion-comprising material.

### 2.3 NO Adsorption

The adsorption experiments have been conducted using a Hiden Isochema IGA-002 gravimetric analyzer. The instrument allows to monitor changes in the gravimetrically determined mass of a sample exposed to a gas at controlled temperature and pressure. For the shown experiments a stainless steel TGA crucible with a volume of 120 μl (supplied by Mettler-Toledo (Schweiz) GmbH, Greifensee, Switzerland) was filled to the top with the respective sample powder of the materials described above. The crucible was mounted to the balance inside the instrument reaction chamber. The temperature in the sample chamber was controlled by a Thermostat at 20° C. during the whole experiment. The chamber was closed and pumped out to a vacuum of less than 5 mbar. After the vacuum was achieved the reaction chamber was filled with artificial air containing 0.4 vol % of NO₂ (supplied by Messer Schweiz AG, Lenzburg, Switzerland) or nitrogen containing 10 vol % of NO, respectively, at 100 mbar/min. The gravimetrical weight was monitored and the change was attributed to the adsorption of NO and converted to adsorption rates based on time and sample weight for comparison purposes.

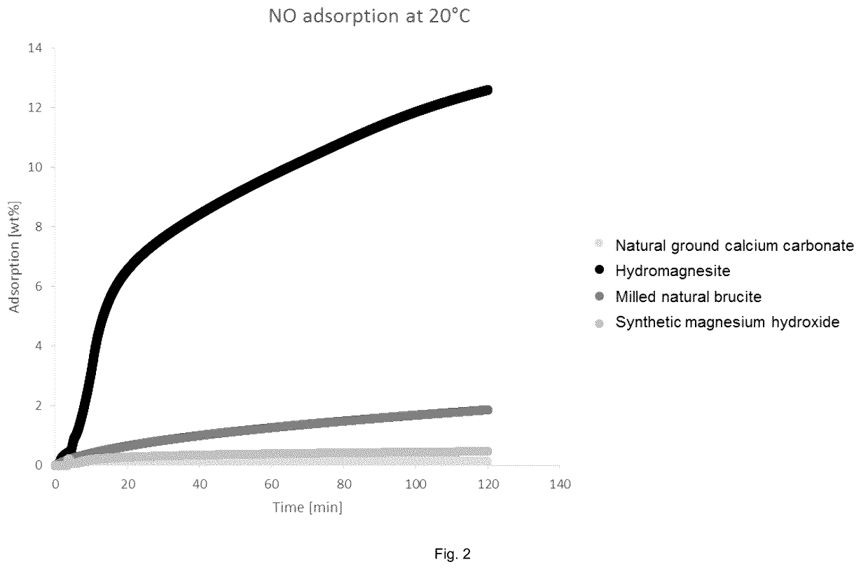

The results for the tested materials are shown in FIG. 2. It can be gathered from FIG. 2 that the particulate magnesium ion-comprising material according to the present invention shows a higher adsorption for NO than the comparative material based on calcium carbonate, i.e. a calcium ion-comprising material.

1. A process for taking up one or more nitrogen oxide(s) from a medium, the process comprising the following steps:
a) providing a gaseous and/or aerosol medium comprising one or more nitrogen oxide(s),
b) providing at least one particulate magnesium ion-comprising material having a BET specific surface area as measured by the BET nitrogen method in the range from 4 to 400 m²/g, and
c) contacting the gaseous and/or aerosol medium of step a) with the at least one particulate magnesium ion-comprising material of step b) for taking up at least a part of the one or more nitrogen oxide(s) from the gaseous and/or aerosol medium onto the surface and/or into the pores of the at least one particulate magnesium ion-comprising material, wherein contacting step c) is carried out at a temperature ranging from −10 to +150° C.

2. The process according to claim 1, wherein the gaseous and/or aerosol medium of step a) is selected from the group comprising air, ambient air, exhaust fumes, factory fumes, household fumes, industrial fumes, vehicle exhausts, fog, smoke and mixtures thereof.

3. The process according to claim 1, wherein the gaseous and/or aerosol medium comprises one or more nitrogen oxide(s) selected from the group comprising NO, NO₂, NO₂⁻, NO₃, N₂O, N₄O, N₂O₃, N₂O₄, N₂O₅, N₄O₆, and mixtures thereof.

4. The process according to claim 1, wherein the gaseous and/or aerosol medium comprises the one or more nitrogen oxide(s) with partial pressures of up to 200 mbar.

5. The process according to claim 1, wherein the at least one particulate magnesium ion-comprising material of step b) is provided in form of a powder, a pellet, a granulated powder, a suspension, a column, a cartridge, a paint, a coating, a filter material, a gabion, or a building material.

6. The process according to claim 1, wherein the at least one particulate magnesium ion-comprising material of step b) is selected from the group comprising a magnesium hydroxide-comprising material, a magnesium carbonate-comprising material, a magnesium oxide-comprising material and mixtures thereof.

7. The process according to claim 1, wherein the at least one particulate magnesium ion-comprising material of step b) has
i) a volume median particle size d₅₀ of <30 mm, determined by laser diffraction, and/or
ii) a BET specific surface area as measured by the BET nitrogen method of from 4 to 200 m²/g, and/or
iii) a particle size distribution d₉₈/d₅₀ of ≥2, determined by laser diffraction.

8. The process according to claim 1, wherein the at least one particulate magnesium ion-comprising material of step b) has a moisture content of at least 0.001 mg/m².

9. The process according to claim 1, wherein contacting step c) is carried out at a temperature ranging from 0 to +80° C.

10. The process according to claim 1, wherein the process comprises a further step d) of washing the at least one particulate magnesium ion-comprising material obtained in step c) in one or more steps such as to remove the one or more nitrogen oxide(s) and/or reaction products thereof from the surface and/or from the pores of the at least one particulate magnesium ion-comprising material.

11. The process according to claim 10, wherein the washing step d) is carried out by contacting the at least one particulate magnesium ion-comprising material obtained in step c) with water, an organic solvent or mixtures thereof.

12. The process according to claim 10, wherein the at least one particulate magnesium ion-comprising material obtained in washing step d) is re-used in process step b) as the at least one particulate magnesium ion-comprising material.

13. A particulate magnesium ion-comprising material obtained by a process for taking up one or more nitrogen oxide(s) from a gaseous and/or aerosol medium according to claim 1.

14. An adsorbing material comprising at least one particulate magnesium ion-comprising material having a BET specific surface area as measured by the BET nitrogen method in the range from 4 to 400 m²/g or as defined in claim 5.

15-16. (canceled)

17. The process according to claim 3, wherein the one or more nitrogen oxide(s) is selected from NO and NO₂.

18. The process according to claim 4, wherein the gaseous and/or aerosol medium comprises the one or more nitrogen oxide(s) with partial pressures of up to 100 mbar.

19. The process according to claim 5, wherein (i) the suspension is an aqueous suspension or suspension in organic solvents and/or (ii) the gabion is placed next to a motorway or a waste incineration plant.

20. The process according to claim 6, wherein the at least one particulate magnesium ion-comprising material of step b) is selected from the group comprising a natural hydromagnesite, a precipitated hydromagnesite, upsalite, magesite, dolomite, half-burned dolomite, natural magnesium oxide, synthetic magnesium oxide, natural magnesium hydroxide, and synthetic magnesium hydroxide.

21. The process according to claim 7, wherein the at least one particulate magnesium ion-comprising material of step b) has
i) a volume median particle size d₅₀ of from about 40 nm to about 2,000 μm; and/or
ii) a BET specific surface area as measured by the BET nitrogen method of from about 6 m²/g to about 175 m²/g; and/or
iii) a particle size distribution d₉₈/d₅₀ of from about 3.2 to about 8.0, determined by laser diffraction.

22. The process according to claim 9, wherein contacting step c) is carried out at a temperature ranging from +10 to +55° C.
